(19) United States
(12) Patent Application Publication
(10) Pub. No.: US 2026/0106084 A1
(43) Pub. Date: Apr. 16, 2026

(54) MULTILAYER ELECTRONIC COMPONENT

(71) Applicant: SAMSUNG ELECTRO-MECHANICS CO., LTD., Suwon-si (KR)

(72) Inventors: Hyun Sik CHAE, Suwon-si (KR); Ji Hyeon LEE, Suwon-si (KR); Jin Bok SHIN, Suwon-si (KR); Eun Jung LEE, Suwon-si (KR); Jong Ho LEE, Suwon-si (KR)

(73) Assignee: SAMSUNG ELECTRO-MECHANICS CO., LTD., Suwon-si (KR)

(21) Appl. No.: 19/215,605

(22) Filed: May 22, 2025

(30) Foreign Application Priority Data
Oct. 10, 2024 (KR) 10-2024-0137882

(51) Int. Cl. H01G 4/30; H01G 4/12

(52) U.S. Cl. CPC H01G 4/30; H01G 4/1227

(57) ABSTRACT

A multilayer electronic component according to an embodiment of the present disclosure may include a body including a capacitance formation portion including a dielectric layer and internal electrodes alternately disposed with the dielectric layer in a first direction, first and second surfaces opposing each other in the first direction, third and fourth surfaces opposing each other in a second direction, and fifth and sixth surfaces opposing each other in a third direction, external electrodes respectively disposed on the third and fourth surfaces, and side margin portions respectively disposed on the fifth and sixth surfaces. C1>C2 is satisfied, where C1 is an average molar ratio of Cs to Ti measured in the side margin portions, and C2 is an average molar ratio of Cs to Ti measured in a central portion of the capacitance formation portion in the first and third directions.

### CROSS-REFERENCE TO RELATED APPLICATION(S)

This application claims benefit of priority to Korean Patent Application No. 10-2024-0137882 filed on Oct. 10, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser, mounted on the printed circuit boards of various types of electronic product, such as image display devices including a liquid crystal display LCD and a plasma display panel PDP, computers, smartphones and mobile phones, and serves to charge or discharge electricity therein or therefrom.

An MLCC may be used as a component in various electronic devices due to having a small size, ensuring high capacitance and being easily mounted.

In order to miniaturize and increase the high capacitance of an MLCC, maximizing the effective area of the internal electrode is required. To maximize the width direction area of the internal electrode, a method has been applied in which a sheet for forming the side margin portions is separately attached to a surface of a multilayer chip in the width direction before sintering and then sintering the chip.

An adhesion between the side margin portions and a ceramic body, sintering behavior of the side margin portions, and a microstructure of the side margin, and the like, are factors greatly affecting the reliability of an MLCC. Therefore, research into an optimal design of components configuring a sheet for forming the side margin portions is required.

### RELATED ART DOCUMENT

### Patent Document

(Patent Document 1) Korean Patent No. 10-2015-0135092

### SUMMARY

An aspect of the present disclosure is to provide a highly reliable multilayer electronic component.

However, problems to be solved by the present disclosure are not limited to the above, and will be more easily understood in the process of describing specific embodiments of the present disclosure.

A multilayer electronic component according to an embodiment of the present disclosure may comprise: a body including a capacitance formation portion including (i) a dielectric layer that includes Ti, and (ii) internal electrodes alternately disposed with the dielectric layer in a first direction, the body having first and second surfaces opposing each other in the first direction, third and fourth surfaces opposing each other in a second direction and connected to the first and second surfaces, and fifth and sixth surfaces opposing each other in a third direction and connected to the first to fourth surfaces, an external electrode disposed on the third and fourth surfaces, and a side margin portion disposed on the fifth and sixth surfaces, the side margin portion including Cs and Ti, wherein C1>C2 is satisfied, where C1 is an average molar ratio of Cs to Ti (Cs/Ti) measured in the side margin portions, and C2 is an average molar ratio of Cs to Ti measured in a central portions of the capacitance formation portion in the first and third directions.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an embodiment of the present disclosure.

FIG. 2 is a perspective view schematically illustrating a body and a side margin portions of the multilayer electronic component of FIG. 1.

FIG. 3 is a perspective view schematically illustrating a body of the multilayer electronic component illustrated in FIG. 1.

FIG. 4 schematically illustrates a cross-sectional view taken along line I-I′ of FIG. 1.

FIG. 5 schematically illustrates a cross-sectional view taken along line II-II′ of FIG. 1.

FIG. 6 schematically illustrates a cross-sectional view of FIG. 5 excluding internal electrodes.

FIG. 7 is a graph illustrating BDV Weibull distribution of embodiments of the present disclosure and comparative examples.

FIG. 8A is a graph illustrating results of a moisture resistance reliability evaluation of embodiments of the present disclosure.

FIG. 8B is a graph illustrating results of a moisture resistance reliability evaluation of comparative examples.

### DETAILED DESCRIPTION

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components in the same reference numerals. Further, throughout the specification, when an element is referred to as “comprising” or “including” an element, it means that the element may further include other elements as well, without departing from the other elements, unless specifically stated otherwise.

In the drawings, a first direction D1 may be defined as a thickness direction or T direction, a second direction D2 may be defined as a length direction or L direction, and a third direction may be defined as a width direction or W direction.

### Multilayer Electronic Component

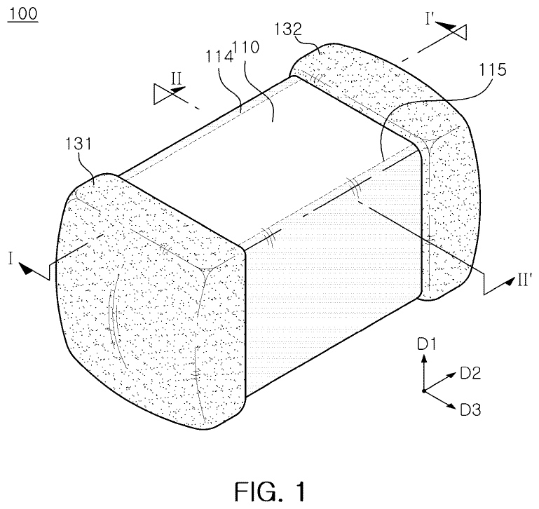

FIG. 1 is a perspective view schematically illustrating a multilayer electronic component according to an embodiment of the present disclosure.

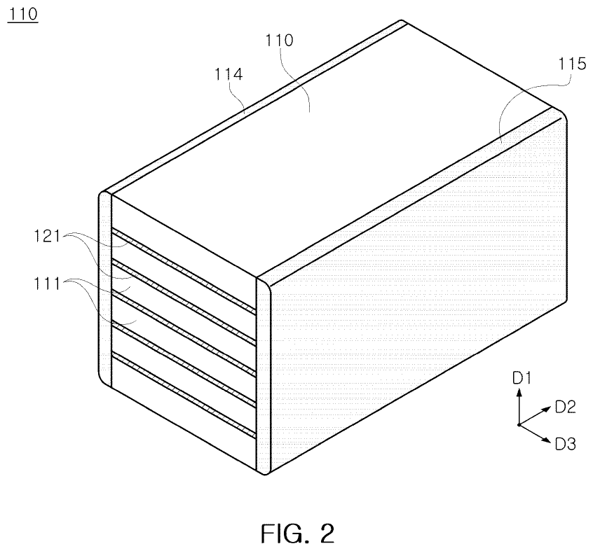

FIG. 2 is a perspective view schematically illustrating a body and a side margin portions of the multilayer electronic component of FIG. 1.

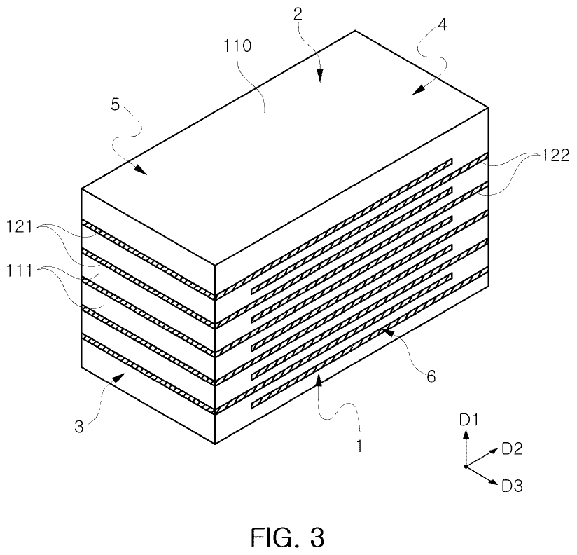

FIG. 3 is a perspective view schematically illustrating a body of the multilayer electronic component of FIG. 1.

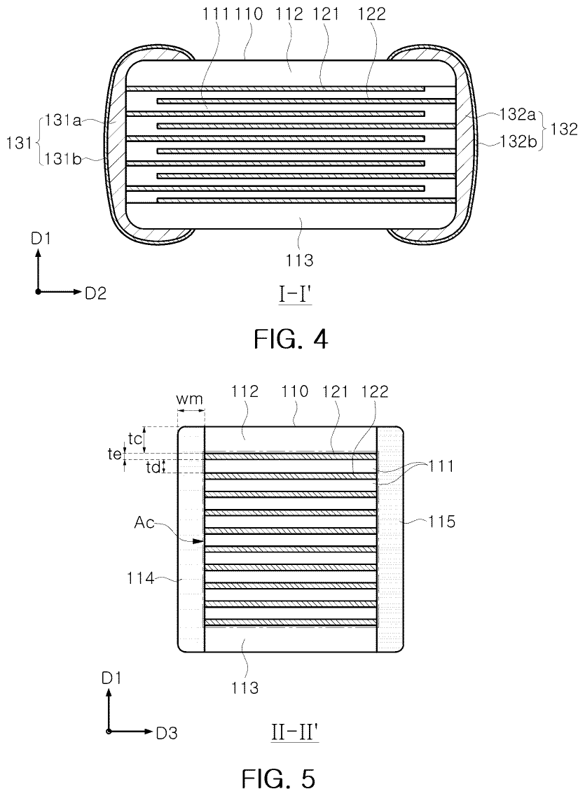

FIG. 4 schematically illustrates a cross-sectional view taken along line I-I′ of FIG. 1.

FIG. 5 schematically illustrates a cross-sectional view taken along line II-II′ of FIG. 1.

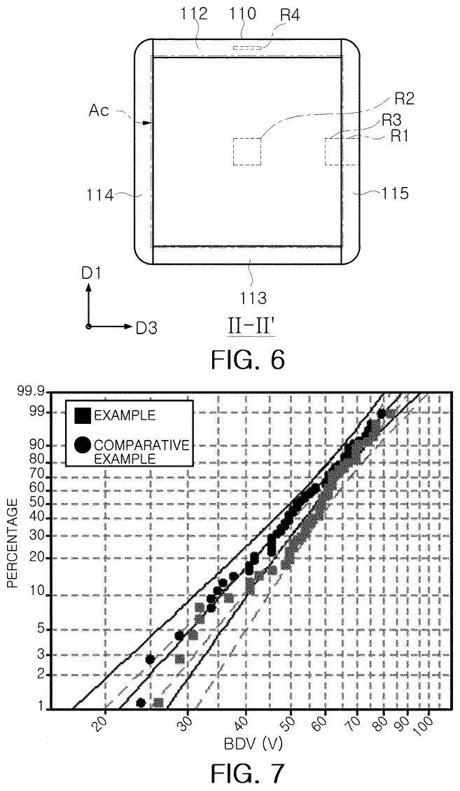

FIG. 6 schematically illustrates a cross-sectional view of FIG. 5 excluding internal electrodes.

Hereinafter, a multilayer electronic component 100 according to an embodiment of the present disclosure will be described in detail with reference to FIGS. 1 to 6. In addition, as an example of a multilayer electronic component, a multilayer ceramic capacitor is described, but the present disclosure is not limited thereto and may also be applied to various multilayer electronic components, such as inductors, piezoelectric elements, varistors, or thermistors.

A multilayer electronic component 100 according to an embodiment of the present disclosure may include a body 110, external electrodes 131 and 132, and the side margin portions 114 and 115.

There is no particular limitation on the specific shape of the body 110, but as illustrated, the body 110 may have a hexahedral shape or a shape similar thereto. Due to shrinkage of ceramic powder particles included in the body 110 during a sintering process or due to the polishing process for the corner portions of the body 110 after sintering, the body 110 may not have a hexahedral shape with entirely straight lines, but may have a substantially hexahedral shape.

The body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3, and 4 and opposing each other in the third direction.

The body 110 may include a capacitance formation portion Ac disposed inside the body 110, and forms a capacitance, including a dielectric layer 111 and internal electrodes 121 and 122 disposed alternately with the dielectric layer 111 in the first direction, a plurality of dielectric layers 111 is in a sintered state, such that boundaries between adjacent dielectric layers 111 may be integrated so as to be difficult to identify without using a scanning electron microscope (SEM).

The dielectric layer 111 may include, for example, a perovskite-type compound represented by ABO₃ as a main component. The perovskite-type compound represented by ABO₃ may include, for example, BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1).

An average thickness td of the dielectric layer 111 is not particularly limited. The average thickness td of the dielectric layer 111 may be, for example, 0.1 μm to 1.0 μm. For example, when the multilayer electronic component 100 has 0603 size (length: about 0.6 mm, width: about 0.3 mm, thickness: about 0.3 mm), the average thickness td of the dielectric layer 111 may be 0.3 μm to 0.7 μm.

The internal electrodes 121 and 122 may include a first internal electrode 121 and a second internal electrode 122 that are alternately disposed in the first direction with the dielectric layer 111 interposed therebetween. The first and second internal electrodes 121 and 122 may be electrically separated from each other by the dielectric layer 111 disposed therebetween.

The first internal electrode 121 may be exposed to the third, fifth, and sixth surfaces 3, 5, and 6 but may be spaced apart from the fourth surface 4. The first internal electrode 121 may be connected to a first external electrode 131 on the third surface 3. The second internal electrode 122 may be exposed to the fourth, fifth, and sixth surfaces 4, 5 and 6 but may be spaced apart from the third surface 3. The second internal electrode 122 may be connected to a second external electrode 132 on the fourth surface 4.

The metal included in the internal electrode 121 and 122 may be one or more of Ni, Cu, Al, Pd, Ag, In, Sn, Ti, and alloys thereof, and more preferably, the internal electrode 121 and 122 may include Ni, but the present disclosure is not limited thereto.

An average thickness te of the internal electrodes 121 and 122 is not particularly limited. The average thicknesses te of the internal electrode 121 and 122 may be, for example, 0.1 μm to 1.0 μm. For example, when the multilayer electronic component 100 has 0603 size (length: about 0.6 mm, width: about 0.3 mm, thickness: about 0.3 mm), the average thicknesses te of the internal electrodes 121 and 122 may be 0.4 μm to 0.6 μm.

The average thickness td of the dielectric layer 111 and the average thickness te of the internal electrodes 121 and 122 respectively refers to average sizes of the dielectric layer 111 and the internal electrodes 121 and 122 in the first direction. The average thickness td of the dielectric layer 111 and the average thickness te of the internal electrodes 121 and 122 may be measured by scanning a cross-section of the body 110 in the first and second direction or a cross-section of the body 110 in the first and third direction with a scanning electron microscope SEM of 10,000× magnification. More specifically, the average thickness td of the dielectric layer 111 may be measured by calculating the average after measuring the thickness at a plurality of points of one dielectric layer 111, for example, at 30 points equally spaced apart from each other in the second direction or the third direction, and then taking the average value. In addition, the average thicknesses te of the internal electrodes 121 and 122 may be measured by calculating the average after measuring the thicknesses at a plurality of points of one internal electrode 121 and 122, for example, at 30 points equally spaced apart from each other in the second direction or in the third direction. The 30 points equally spaced apart from each other may be designated in the capacitance formation portion Ac. Meanwhile, when the average value measurements are performed for each of 10 dielectric layers 111 and 10 internal electrodes 121 and 122, and then the average values are calculated, the average thickness td of the dielectric layer 111 and the average thicknesses te of the internal electrodes 121 and 122 may be further generalized.

The body 110 may include cover portions 112 and 113 respectively disposed on both surfaces of the capacitance formation portion Ac opposing in the first direction. The cover portions 112 and 113 may basically serve to prevent damage to the internal electrode due to physical or chemical stress. The cover portions 112 and 113 may have a similar configuration to the dielectric layer 111 except for not including an internal electrode.

An average thicknesses tc of the cover portions 112 and 113 may not be particularly limited. The average thickness tc of the cover portions 112 and 113 may be, for example, 5 μm or more and 100 μm or less. For example, when the multilayer electronic component 100 has 0603 size (length: about 0.6 mm, width: about 0.3 mm, thickness: about 0.3 mm), the average thickness tc of the cover portions 112 and 113 may be 10 μm or more and 30 μm or less. The average thicknesses tc of the cover portions 112 and 113 may refer to an average thickness of each of the first cover portion 112 and the second cover portion 113.

The average thicknesses tc of the cover portions 112 and 113 may refer to an average size of the cover portions 112 and 113 in the first direction, and may be an average value of sizes in the first direction measured at 5 points equally spaced apart from each other in a cross-section of the body 110 in the first and second directions or a cross-section of the body 110 in the first and third directions.

The side margin portions 114 and 115 may be disposed on the fifth and sixth surfaces 5 and 6 of the body 110, respectively. The multilayer electronic component 100 may include the first side margin portion 114 disposed on the fifth surface 5 and a second margin portion 115 disposed on the sixth surface 6. The side margin portions 114 and 115 may refer to a region between both ends of the internal electrodes 121 and 122 and a boundary surface of the body 110 in a cross-section of the multilayer electronic component 100 in the first and third direction.

The side margin portions 114 and 115 may include a perovskite-type compound represented by ABO₃ as a main component. The perovskite-type compound represented by ABO₃ may include, for example, BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1).

An average thicknesses wm of the side margin portions 114 and 115 may not be particularly limited. The average thicknesses wm of the side margin portions 114 and 115 may be, for example, 3 μm or more and 100 μm or less. For example, when the multilayer electronic component 100 has 0603 size (length: about 0.6 mm, width: about 0.3 mm, thickness: about 0.3 mm), the average thickness wm of the side margin portions 114 and 115 may be 10 μm or more and 20 μm or less. Average thicknesses wm of the side margin portions 114 and 115 refers to an average thickness of each of the first side margin portion 114 and the second side margin portion 115.

An average thickness wm of the side margin portions 114 and 115 may refer to an average size of the side margin portions 114 and 115 in the third direction, and may be an average value of sizes in the third direction measured at 5 points equally spaced apart from each other in a cross-section of the body 110 in the first and third directions.

External electrodes 131, 132 may be disposed on the third and fourth surfaces 3 and 4 of the body 110, respectively. The multilayer electronic component 100 may include the first external electrode 131 disposed on the third surface 3 and the second external electrode 132 disposed on the fourth surface 4. The first external electrode 131 may be disposed on the third surface 3 and may extend onto portions of the first, second, fifth and sixth surfaces 1, 2, 5, and 6, and the second external electrode 132 may be disposed on the fourth surface 4 and may extend onto portions of the first, second, fifth and sixth surfaces 1, 2, 5, and 6.

Types or shapes of the external electrodes 131 and 132 may not be particularly limited, and may have a multilayer structure. For example, the external electrodes 131 and 132 may include base electrode layers 131a and 132a in contact with the internal electrodes 121 and 122 and plating layers 131b and 132b disposed on the base electrode layers 131a and 132a.

The base electrode layers 131a and 132a may be sintered electrode layers including metal and glass. The metal included in the base electrode layers 131a and 132a may include, for example, Cu, Ni, Sn, Al, Pd, Ag, and/or alloys thereof. The glass included in the base electrode layers 131a and 132a may include, for example, one or more oxides of Ba, Ca, Zn, Al, B, and Si.

Meanwhile, the base electrode layers 131a and 132a may be configured by only the sintered electrode layer including metal and glass, but the present disclosure may not be limited thereto. The base electrode layers 131a, 132a may include, for example, a sintered electrode layer including metal and glass, and a resin electrode layer disposed on the sintered electrode layer and including metal particles and resin.

The metal included in the resin electrode layer may include, for example, Cu, Ni, Pd, Ag, Pb, Sn and/or alloys thereof. The resin included in the resin electrode layer may include, for example, one or more of epoxy resin, acrylic resin, and ethyl cellulose.

The plated layers 131b, 132b may include, for example, Ni, Sn, Pd and/or alloys thereof, and may be formed of a plurality of layers. The plating layers 131b and 132b may be, for example, Ni plating layer or Sn plating layer, and may also be in the form in which the Ni plating layer and the Sn plating layer are formed sequentially thereon. Additionally, the plating layers 131b and 132b may include a plurality of Ni plating layers and/or a plurality of Sn plating layers.

Although the drawing describes a structure in which a multilayer electronic component 100 has two external electrodes 131 and 132, it may not be limited thereto, and the number or shape of the external electrodes 131 and 132 may be changed depending on the shape of the internal electrodes 121 and 122 or other purposes.

When a composition of the dielectric layer 111 included in the capacitance formation portion Ac and the composition of the side margin portions 114 and 115 are the same, sintering of the capacitance formation portion Ac may occur before the side margin portions 114 and 115. This is because the internal electrodes 121 and 122 including a conductive metal having a lower sintering initiation temperature than dielectric material, are disposed in the capacitance formation portion Ac. When a sintering mismatch occurs between the body 110 and the side margin portions 114 and 115, it may cause a shape defect of the multilayer electronic component 100, which may lead to reducing connectivity between the internal electrodes 121 and 122 and the external electrodes 131 and 132.

Accordingly, the multilayer electronic component 100 according to an embodiment of the present disclosure satisfies C1>C2, where C1 is an average molar ratio of Cs to Ti Cs/Ti measured in the side margin portions 141 and 142, and C2 is an average molar ratio of Cs to Ti measured in the central portion of the capacitance formation portion Ac in the first and third directions.

Cesium Cs has a low melting point and may perform as a low-temperature sintering aid to lower the sintering temperature of dielectric materials by forming a liquid form at low temperatures. That is, by satisfying C1>C2, the sintering initiation temperature of the side margin portions 114 and 115 may be lowered. This may reduce the sintering mismatch between the body 110 and the side margin portions 114 and 115, thereby preventing the deterioration of connectivity between internal electrode and external electrode caused by shape defects of the multilayer electronic component 100.

In addition, by satisfying C1>C2, grain growth of dielectric grains included in the side margin portions 114 and 115 may be suppressed and the sintering density of the side margin portions 114 and 115 may be improved. This may improve hardness of the side margin portions 114 and 115, and thereby improve mechanical strength of the multilayer electronic component 100.

The content of Cs included in the side margin portions 114 and 115 may be, for example, 0.5 mol or more and 2.0 mol or less based on 100 mol of Ti.

In an embodiment, the C1 and C2 may satisfy 5≤C1/C2≤40. More preferably, the C1 and C2 may satisfy 10≤C1/C2≤40, or 20≤C1/C2≤40, or 20≤C1/C2≤30. As a result, the effect of improving the sintering density of the side margin portions 114 and 115 of the present disclosure may be further enhanced. When C1/C2 exceeds 40, sintering may not proceed or the dielectric properties of the multilayer electronic component 100 may deteriorate.

Meanwhile, Cs may be added to the sheet for forming the side margin portions, but Cs may not be added to the sheet for forming the dielectric layer. When Cs is added to the sheet for forming the dielectric layer, the sintering initiation temperature of the body 110 may be further lowered, and thus, sintering mismatch between the body 110 and the side margin portions 114 and 115 may additionally occur. That is, the Cs included in the capacitance formation portion Ac may be diffused from the side margin portions 114 and 115, and in particular, Cs may be distributed more in the boundary portion of the capacitance formation portions Ac adjacent to one of the side margin portions 114 and 115 than in the side margin portions 114 and 115. For example, where C3 is an average molar ratio of Cs to Ti measured in the boundary portion of the capacitance formation portion Ac adjacent to one of the side margin portions 114 and 115, C3>C1>C2 may satisfied. A boundary portion R3 of the capacitance formation portion Ac adjacent to the side margin portions 114 and 115, refers to a region included inner region of the capacitance formation portion Ac, and may mean a region adjacent to the boundary with the side margin portions 114 and 115 among the inner region of the capacitance formation portion Ac.

In addition, Cs may be added to the sheet for forming the side margin portions, but Cs may not be added to the sheet for forming the cover portion. When Cs is added to the sheet for forming the cover portion, sintering mismatch between the body 110 and the side margin portions 114 and 115 may additionally occur. That is, Cs included in the cover portion 112 and 113 may be diffused from the side margin portions 114 and 115, and for example, where C4 is an average molar ratio of Cs to Ti measured in the central portion of the cover portions 112 and 113 in the third direction, C1>C4 may be satisfied. The C4 may not be particularly limited and may be 0 or more and less than C1.

The method for measuring the C1 to C4 may not be particularly limited. For example, C1 to C4 may be measured from an image observed by using a Scanning Electron Microscope-Energy Dispersive X-ray Spectrometer SEM-EDS, a Transmission Electron Microscope-Energy Dispersive X-ray Spectrometer TEM-EDS, a Scanning Transmission Electron Microscope-Energy Dispersive X-ray Spectrometer STEM-EDS, or a Field Emission-scanning Electron Microscope-Energy Dispersive X-ray Spectrometer FE-SEM-EDS. Other methods and/or tools appreciated by one of ordinary skill in the art, even if not described in the present disclosure, may also be used.

More specifically, as illustrated in FIG. 6, the multilayer electronic component 100 may be polished up to ½ point in the second direction to expose a cross-section of the multilayer electronic component 100 in the first and third directions. Thereafter, the contents mol% of Cs and Ti in central portion R1 of the side margin portions in the first direction may be measured by using Point-EDS, and then the molar ratio of Cs to Ti may be calculated. Meanwhile, the molar ratio of Cs to Ti at a plurality of points, for example, five or more points, in the central portion R1 of one of the side margin portions in the first and third direction may be measured by using FE-SEM-EDS (acceleration voltage: 15 kV, magnification: 50,000 times), and the C1 may be measured by averaging the measured values. The central portion R1 of one of the side margin portions in the first direction may mean, for example, a region having a size of 5 μm×4 μm (third direction×first direction) based on the center of one of the side margin portions 114 and 115 in the first and third directions.

Similarly, the C2 may be measured by measuring the molar ratio of Cs to Ti at a plurality of points, for example, five or more points, in the central portion R2 of the capacitance formation portion in the first and third directions by using FE-SEM-EDS (acceleration voltage: 15 kV, magnification: 50,000 times), and averaging the measured values. The five or more points may be designated in the dielectric layer 111. The central portion R2 of the capacitance formation portion in the first and third directions may mean, for example, a region having a size of 5 μm×4 μm (third direction×first direction) based on center of the capacitance formation portion Ac in the first and third directions.

The C3 may be measured by measuring the molar ratio of Cs to Ti at a plurality of points, for example, five or more points, in the boundary portion R3 of the capacitance formation portion adjacent to one of the side margin portions by using FE-SEM-EDS (acceleration voltage: 15 kV, magnification: 50,000 times), and averaging the measured values. The five or more points may be designated in the dielectric layer 111. The boundary portion R3 of the capacitance formation portion adjacent to the side margin portions may mean a region having a size of 5 μm×4 μm (third direction×first direction) contacting a boundary surface with the side margin portions at a center of the capacitance formation portion Ac in the first direction.

In addition, the C4 may be measured by measuring the molar ratio of Cs to Ti at a plurality of points, for example, five or more points, in the central portion R4 of the cover portion in the first and third directions by using Point-EDS and averaging the measured values.

Meanwhile, similar to Cs, a method of adding Na and/or Li, which have low melting points, as low-temperature sintering aid to the side margin portions 114 and 115 may also be considered. However, Na or Li included in the side margin portions 114 and 115 may easily volatilize during the sintering process of the side margin portions 114 and 115 and contaminate a sintering furnace, and may not be uniformly distributed in the side margin portions 114 and 115. On the other hand, Cs may be added in a liquid form to the sheet for forming the side margin portions, in which case the problem of sintering furnace contamination may be prevented.

Therefore, the side margin portions 114 and 115 may substantially not contain Na and Li. In some embodiments, the side margin portions 114 and 115 may be substantially free of Na and Li. In the present disclosure, “substantially not including Na and Li” and “substantially free of Na and Li” may each mean not intentionally adding Na and Li components to the side margin portions 114 and 115. However, in the manufacturing process of the multilayer electronic component 100, there may be a possibility that a very residual amount of Na and Li components may be included unexpectedly. Considering this situation, the content of Na included in the side margin portions 114 and 115 may be 0.001 mol or less relative to 100 mol of Ti included in the side margin portions 114 and 115, and the content of Li included in the side margin portions 114 and 115 may be 0.001 mol or less relative to 100 mol of Ti included in the side margin portions 114 and 115.

Meanwhile, an average size of the dielectric grains included in the capacitance formation portion Ac and the side margin portions 114 and 115 may not be particularly limited. However, grain growth of the dielectric grains included in the side margin portions 114 and 115 may be suppressed by Cs. In addition, the grain growth of dielectric grains included in the boundary portion of the capacitance formation portion Ac adjacent to the side margin portions 114 and 115 including Cs diffused from the side margin portions 114 and 115 may also be suppressed.

Accordingly, in an embodiment, when an average size of the dielectric grains included in the side margin portions 114 and 115 is referred to as G1, an average size of the dielectric grains included in the central portion of the capacitance formation portion Ac in the first and third directions is referred to as G2, and an average size of the dielectric grains included in the boundary portion of the capacitance formation portions Ac adjacent to the side margin portions 114 and 115 is referred to as G3, G2>G3>G1 may satisfied.

The G1 may be measured from an image of the central portion R1 of the side margin portions in the first direction which is observed by using a scanning electron microscope SEM, the G2 may be measured from an image of the central portion R2 of the capacitance formation portion in the first and third directions which is observed by using a scanning electron microscope SEM, and the G3 may be measured from an image of the boundary portion R3 of the capacitance formation portion adjacent to the side margin portions which is observed by using a scanning electron microscope SEM. Other methods and/or tools appreciated by one of ordinary skill in the art, even if not described in the present disclosure, may also be used.

The G1 to G3 may not be particularly limited, but for example, the G1 may be 150 nm to 250 nm, the G2 may be 220 nm to 320 nm, and the G3 may be 185 nm to 285 nm.

The dielectric layer 111 and the side margin portions 114 and 115 may further include other subcomponents.

For example, the dielectric layer 111 and the side margin portions 114 and 115 may further include Mg. Similar to Cs, Mg may suppress the grain growth of the dielectric grains included in the side margin portions 114 and 115.

In an embodiment, an average molar ratio of Mg to Ti (Mg/Ti) measured in the side margin portions 114 and 115 may be greater than an average molar ratio of Mg to Ti (Mg/Ti) measured in the central portion of the capacitance formation portion Ac in the first and third direction. Accordingly, the sintering mismatch between the body 110 and the side margin portions 114 and 115 may be reduced and the sintering density of the side margin portions 114 and 115 may be improved.

However, Mg may have a high reactivity with Ni mainly included in the internal electrodes 121 and 122. Accordingly, when Mg is excessively added to the side margin portions 114 and 115, the Mg of the side margin portions 114 and 115 and the Ni of the internal electrodes 121 and 122 may react, causing an excessive Ni secondary phase to be formed at both ends of the internal electrodes 121 and 122 in the third direction. The Ni secondary phase may reduce an electrical characteristics of the multilayer electronic component 100. On the other hand, Cs may have low reactivity with Ni. Accordingly, in an embodiment, the average molar ratio of Cs to Ti (Cs/Ti) measured in the side margin portions 114 and 115 may be greater than the average molar ratio of Mg to Ti (Mg/Ti) measured in the side margin portions 114 and 115. Accordingly, excessive formation of Ni secondary phase may be prevented, sintering mismatch between the body 110 and the side margin portions 114 and 115 may be reduced, and the sintering density of the side margin portions 114 and 115 may be improved.

A method for measuring the average molar ratio of Mg to Ti (Mg/Ti) may be the same as the method for measuring C1 and C2, except for measuring the content of Mg (mol%) instead of Cs. Other methods and/or tools appreciated by one of ordinary skill in the art, even if not described in the present disclosure, may also be used. Hereinafter, a repeated description of the measurement method will be omitted.

For example, the dielectric layer 111 and the side margin portions 114 and 115 may further include Sn. Similar to Cs, Sn may suppress the grain growth of dielectric grains included in the side margin portions 114 and 115.

In an embodiment, an average molar ratio of Sn to Ti (Sn/Ti) measured in the side margin portions 114 and 115 may be greater than an average molar ratio of Sn to Ti (Sn/Ti) measured in the central portion of the capacitance formation portion Ac in the first and third directions. Accordingly, the sintering mismatch between the body 110 and the side margin portions 114 and 115 may be reduced and the sintering density of the side margin portions 114 and 115 may be improve.

In addition, by the diffusion of Sn, an average molar ratio of Sn to Ti (Sn/Ti) measured in the boundary portion of the capacitance formation portion Ac adjacent to one of the side margin portions 114 and 115 may be greater than the average molar ratio of Sn to Ti (Sn/Ti) measured in the side margin portions 114 and 115, but the present disclosure may not be limited thereto.

The content of Sn included in the side margin portions 114 and 115 may be, for example, 2.0 mol or more and 3.2 mol or less based on 100 mol of Ti. A method for measuring the average molar ratio of Sn to Ti (Sn/Ti) may be the same as the method for measuring C1 and C2, except for measuring the content of Sn (mol%) instead of Cs. Other methods and/or tools appreciated by one of ordinary skill in the art, even if not described in the present disclosure, may also be used.

For example, the dielectric layer 111 and the side margin portions 114 and 115 may further include one or more of Si and Al. Similar to Cs, Si may suppress the grain growth of dielectric grains included in the side margin portions 114 and 115.

In an embodiment, the average molar ratio of Si to Ti (Si/Ti) measured in the side margin portions 114 and 115 may be greater than the average molar ratio of Si to Ti (Si/Ti) measured in the central portion of the capacitance formation portion Ac in the first and third directions. Accordingly, the sintering mismatch between the body 110 and the side margin portions 114 and 115 may be reduced and the sintering density of the side margin portions 114 and 115 may be improve.

In addition, by the diffusion of Si, the average molar ratio of Si to Ti (Si/Ti) measured in the boundary portion of capacitance formation portion Ac adjacent to one of the side margin portions 114 and 115 may be greater than the average molar ratio of Si to Ti (Si/Ti) measured in the side margin portions 114 and 115, but the present disclosure may not be limited thereto.

The content of Si included in the side margin portions 114 and 115 may be, for example, 1.5 mol or more and 2.5 mol or less based on 100 mol of Ti.

Similar to Si, A1 may also be an element that may contribute to low-temperature densification through liquefaction during sintering. In addition, Al may improve the high temperature voltage resistance characteristics of the multilayer electronic component 100 and may act as an acceptor to reduce electron concentration, thereby improving the reliability of the multilayer electronic component 100.

In an embodiment, an average molar ratio of Al to Ti (Al/Ti) measured in the side margin portions 114 and 115 may be less than an average molar ratio of Al to Ti (Al/Ti) measured in the central portion of the capacitance formation portion Ac in the first and third directions.

The content of Al included in the side margin portions 114 and 115 may be, for example, 35 mol or more and 45 mol or less based on 100 mol of Ti.

A method for measuring the average molar ratio of Si to Ti (Si/Ti) and Al to Ti (Al/Ti) may be the same as the method for measuring C1 and C2, except for measuring the content of Si (mol%) and Al (mol%) instead of Cs. Other methods and/or tools appreciated by one of ordinary skill in the art, even if not described in the present disclosure, may also be used.

The dielectric layer 111 and the side margin portions 114 and 115 may further include one or more of Dy, Tb, Y, Sc, La, Nd, Eu, Gd, Ho, Er, Yb, and Lu. The rare earth elements may improve the reliability of the multilayer electronic component 100. A total content of the rare earth elements included in the side margin portions 114 and 115 may be, for example, 0.6 mol or more and 3.0 mol or less based on 100 mol of Ti.

The dielectric layer 111 and the side margin portions 114 and 115 may further include one or more of Mn, V, Cr, Fe, Ni, Co, and Zn. A variable valence acceptor element may serve to lower the sintering temperature and improving the high-temperature voltage resistance characteristics of the multilayer electronic component 100. A total content of the variable valence acceptor element included in the side margin portions 114 and 115 may be, for example, 0.2 mol or more and 1.4 mol or less based on 100 mol of Ti.

In order to appropriately control the microstructure of the side margin portions 114 and 115, the side margin portions 114 and 115 may further include, for example, Mg, Dy, Mn, V, Si, and Al among the aforementioned subcomponents.

Hereinafter, an example of a method for forming a multilayer electronic component 100 will be described.

First of all, ceramic powder for forming a dielectric layer 111 are prepared. The ceramic powder may include, for example, BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1). BaTiO₃ powder may be synthesized, for example, by reacting a titanium raw material such as titanium dioxide with a barium raw material such as barium carbonate. A synthesizing method of the ceramic powder may include methods, for example, a solid phase method, a sol-gel method, a hydrothermal synthesis method, or the like, but the present disclosure may not be limited thereto. Next, the prepared ceramic powder are dried and ground, and then an organic solvent such as ethanol, a binder such as polyvinyl butyral, and other subcomponents are mixed to prepare a ceramic slurry, and then the ceramic slurry is applied and dried on a carrier film to prepare a sheet for forming a dielectric layer.

Next, conductive paste for an internal electrode containing metal powder, binder, organic solvent, or the like is printed onto the dielectric layer sheet with a predetermined thickness using a screen printing method or a gravure printing method, thereby forming an internal electrode pattern.

Thereafter, the sheet for forming a dielectric layer having the internal electrode pattern printed thereon is peeled off from the carrier film, and then a predetermined amount of layers are laminated and pressed to form a ceramic laminate. On the upper and lower portions of the ceramic laminate, a sheet forming a cover portion without an internal electrode pattern, may be laminated in a predetermined amount of layers to form the cover portion 112 and 113 after sintering. Thereafter, the ceramic laminate is cut to have a predetermined size of a chip. At this time, the ends portion of the internal electrode patterns may be exposed on both surfaces of the chip opposing each other in the third direction.

Next, a sheet for forming a margin portion may be attached to both surfaces of the chip opposing in the third direction and then sintered to form the body 110 and the side margin portions 114 and 115. The sintering temperature may be, for example, 1000° C. or higher and 1400° C. or lower, but the present disclosure may not be limited thereto.

Meanwhile, the sheet for forming the margin portion may be formed in a similar method to the sheet for forming the dielectric layer, but the type and content of subcomponents included in the sheet for forming the margin portion may be different from those included in the sheet for forming the dielectric layer.

For example, Cs may be added together with the main component BaTiO₃ to the sheet for forming the margin portion, and Cs may not be added to the sheet for forming the dielectric layer. Therefore, the condition C1>C2 may be satisfied. However, the present disclosure may not be limited thereto, and a less amount of Cs may be added to the sheet for forming a dielectric layer than to the sheet for forming the margin portion.

In addition, the sheet for forming the side margin portions may contain, in addition to Cs, rare earth elements such as Mg, Sn, Si, Al, Dy, Tb, Y, Sc, La, Nd, Eu, Gd, Ho, Er, Yb, Lu, and/or variable valence acceptor elements such as Mn, V, Cr, Fe, Ni, Co, and Zn as subcomponents.

The subcomponents may be added in the form of oxides and/or carbonates to the sheet for forming the side margin portions, but the present disclosure may not be limited thereto.

Next, the external electrodes 131 and 132 may be formed. The base electrode layers 131a and 132a may be formed by dipping the body 110 to which the side margin portions 114 and 115 are attached into a conductive paste containing metal powder, glass frit, binder, and organic solvent, or the like, followed by sintering the conductive paste at a temperature of 500° C. to 900° C. When the base electrode layers 131a and 132a have a form in which the sintered electrode layer and the resin electrode layer are sequentially laminated, a conductive resin composition including metal powder, resin, binder, and organic solvent, or the like may be applied onto the sintered electrode layer, followed by curing heat treatment at a temperature of 250° C. to 550° C. to form the resin electrode layer.

The plated layers 131b and 132b may be formed, for example, using an electrolytic plating method and/or an electroless plating method.

### EXAMPLE

In the case of an example, a sheet for forming the side margin portions was produced with a dielectric composition having Cs content of 1.0 mol as converted to Cs₂O based on 100 mol of BaTiO₃, Mg content of 1.0 mol as converted to MgO based on 100 mol of BaTiO₃, and, in addition, including Dy, Mn, Si, Al, and V. Additionally, a sheet for forming the dielectric layer was produced with a dielectric composition having Mg content of 0.467 mol as converted to MgO based on 100 mol of BaTiO₃ and including additional components such as Dy but not including Cs.

An internal electrode conductive paste including Ni powder, organic solvent, and binder, or the like, was applied to the sheet for forming the dielectric layer with a predetermined thickness to form the internal electrode pattern, and then the sheets for forming the dielectric layer on which the internal electrode pattern is formed was laminated and pressed to form the ceramic laminate.

The ceramic laminate may be cut to a predetermined chip size, and a sheet for forming the side margin portions may be attached to both surfaces of the cut chip opposing each other in the third direction, and then the body and the side margin portions were formed by sintering under conditions of hydrogen concentration of 0.56% and sintering temperature of 1180° C.

Finally, a sample chip of size 0603 (length: approximately 0.6 mm, width: approximately 0.3 mm, thickness: approximately 0.3 mm) was prepared by forming external electrodes on both surfaces of the body opposing each other in the second direction.

For the comparative example, the sample chip was manufactured using the same method as in the example, but Cs was not added to the sheet for forming the side margin portions.

The breakdown voltage BDV evaluation was conducted on sixty sample chips each for the examples and comparative examples. A DC voltage was applied to the examples and comparative examples at a boost rate of 20 V/s using a Keithley 2400, and the voltage at which the leakage current exceeded 20 mA was measured as the BDV.

FIG. 7 is a graph illustrating the BDV Weibull distribution of examples and comparative examples. Referring to FIG. 7, it may be confirmed that the example has a superior breakdown voltage (BDV) compared to the comparative example. It is believed that, in the case of the example, the grain growth of the dielectric grains included in the side margin portions may be suppressed by satisfying C1>C2, and a voltage applied to each dielectric grain may be reduced.

Next, a moisture resistance reliability evaluation was conducted on four hundred sample chips, each for the examples and comparative examples. The moisture resistance reliability evaluation was conducted for two hours in an environment of 85° C. temperature, 85% humidity, and 1 Vr.

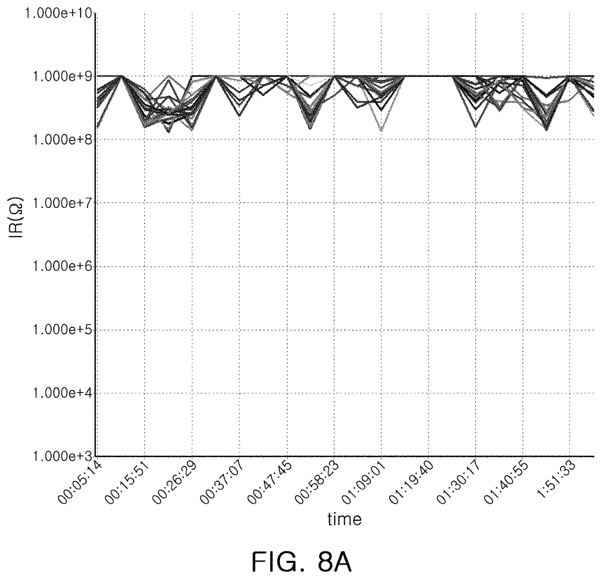

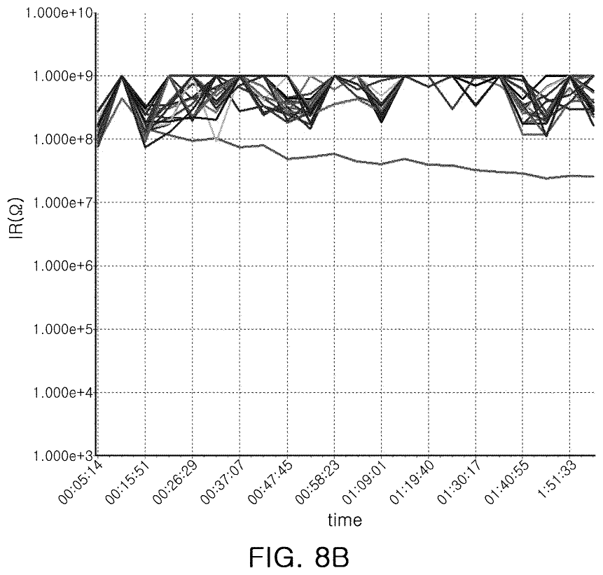

FIG. 8A is a graph illustrating results of the moisture resistance reliability evaluation of the example. FIG. 8B is a graph illustrating the results of the moisture resistance reliability evaluation of a comparative example. Referring to FIGS. 8A and 8B, in the example, there was no sample chip with IR degradation, but in the comparative example, there was a sample chip with IR degradation. It may be confirmed that the moisture resistance reliability of the multilayer electronic component is improved by satisfying C1>C2.

The present disclosure is not limit the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression ‘an example embodiment’ does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

The terms “first,” “second,” and the like may be used to distinguish one element from another, and may not limit a sequence and/or an importance, or others, in relation to the elements. In some cases, a first element may be referred to as a second element, and similarly, a second element may be referred to as a first element without departing from the scope of right of the example embodiments.

As one of the various effects of the present disclosure, a multilayer electronic component with excellent reliability can be provided.

While the embodiments have been illustrated and described above, it will be configured as apparent to those skilled in the art that modifications and variations could be made without departing from the scope of the present disclosure as defined by the appended claims.

What is claimed is:

1. A multilayer electronic component comprising:
a body including a capacitance formation portion including (i) a dielectric layer that includes Ti, and (ii) internal electrodes alternately disposed with the dielectric layer in a first direction, the body having first and second surfaces opposing each other in the first direction, third and fourth surfaces opposing each other in a second direction and connected to the first and second surfaces, and fifth and sixth surfaces opposing each other in a third direction and connected to the first to fourth surfaces;
an external electrode disposed on the third and fourth surfaces; and
a side margin portion disposed on the fifth and sixth surfaces, the side margin portion including Cs and Ti,
wherein C1>C2 is satisfied, where C1 is an average molar ratio of Cs to Ti (Cs/Ti) measured in the side margin portion, and C2 is an average molar ratio of Cs to Ti measured in a central portion of the capacitance formation portion in the first and third directions.

2. The multilayer electronic component of claim 1, wherein C1 and C2 satisfy 5≤C1/C2≤40.

3. The multilayer electronic component of claim 1, wherein C3>C1>C2 is satisfied, where C3 is an average molar ratio of Cs to Ti measured in a boundary portion of the capacitance formation portion adjacent to the side margin portion.

4. The multilayer electronic component of claim 1, wherein the body further includes a cover portion disposed on two surfaces of the capacitance formation portion opposing each other in the first direction,
wherein C1>C4 is satisfied, where C4 is an average molar ratio of Cs to Ti measured in a central portion of the cover portion in the third direction.

5. The multilayer electronic component of claim 1, wherein G2>G3>G1 is satisfied, where G1 is an average size of dielectric grains included in the side margin portion, G2 is an average size of dielectric grains included in the central portion of the capacitance formation portion in the first and third directions, and G3 is an average size of dielectric grains included in a boundary portion of the capacitance formation portion adjacent to the side margin portion.

6. The multilayer electronic component of claim 1, wherein the side margin portion further includes Mg.

7. The multilayer electronic component of claim 6, wherein an average molar ratio of Mg to Ti (Mg/Ti) measured in the side margin portion is greater than an average molar ratio of Mg to Ti (Mg/Ti) measured in the central portion of the capacitance formation portion in the first and third directions.

8. The multilayer electronic component of claim 1, wherein the side margin portion further includes Sn.

9. The multilayer electronic component of claim 8, wherein an average molar ratio of Sn to Ti (Sn/Ti) measured in the side margin portion is greater than an average molar ratio of Sn to Ti (Sn/Ti) measured in the central portion of the capacitance formation portion in the first and third directions.

10. The multilayer electronic component of claim 1, wherein the side margin portion further includes one or more selected from Si and Al.

11. The multilayer electronic component of claim 10, wherein an average molar ratio of Si to Ti (Si/Ti) measured in the side margin portion is greater than an average molar ratio of Si to Ti (Si/Ti) measured in the central portion of the capacitance formation portion in the first and third directions, and
an average molar ratio of Al to Ti (Al/Ti) measured in the side margin portion is less than an average molar ratio of Al to Ti (Al/Ti) measured in the central portion of the capacitance formation portion in the first and third directions.

12. The multilayer electronic component of claim 1, wherein the side margin portion further includes one or more selected from Dy, Tb, Y, Sc, La, Nd, Eu, Gd, Ho, Er, Yb, and Lu.

13. The multilayer electronic component of claim 1, wherein the side margin portion further includes one or more selected from Mn, V, Cr, Fe, Ni, Co, and Zn.

14. The multilayer electronic component of claim 1, wherein the side margin portion further includes Mg, Dy, Mn, V, Si, and Al.

15. The multilayer electronic component of claim 1, wherein the side margin portion is substantially free of Na and Li.

16. The multilayer electronic component of claim 1, wherein the dielectric layer further includes Mg.

17. The multilayer electronic component of claim 1, wherein the dielectric layer further includes Dy.

18. The multilayer electronic component of claim 1, wherein the side margin portion is substantially free of either Na or Li.
